(19) United States
(12) Patent Application Publication
(10) Pub. No.: US 2010/0275018 A1
(43) Pub. Date: Oct. 28, 2010

(54) SYSTEM AND METHOD FOR CONVERSION AND DISTRIBUTION OF GRAPHICAL OBJECTS

(76) Inventor: Thomas Jam PEDERSEN, Virum (DK)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/808,228

(22) PCT Filed: Dec. 19, 2008
(86) PCT No.: PCT/DK2008/000446

§ 371 Date: Jun. 15, 2010

Related U.S. Application Data
(60) Provisional application No. 61/015,253, filed on Dec. 20, 2007.

(51) Int. Cl. G06F 15/16; H04L 9/00; G06K 9/36; G06T 17/00

(52) U.S. Cl. 713/168; 709/203; 382/285; 345/420; 709/229

(57) ABSTRACT

A system for converting a first digital representation of a graphical object defined in two dimensions, such as a floor plan of a building such as a house or an apartment, into a second digital representation of said graphical object, said second digital representation defined in three dimensions, said system comprising means for converting the first digital representation into a vector based representation by means of an computer implemented algorithm, and means for converting said vector based representation of the first digital representation into a three dimensional representation of the graphical object. Furthermore the invention relates to a system for secure administration and/or provision of protected data files in a computer network, such as the Internet or a local LAN, said computer network comprising at least one server and a plurality of clients. Finally the invention relates to a system that allows 3^{rd} party suppliers to be able to provide applications to be launched on a client.

The present invention relates to a system and a method for converting two dimensional representations, such as drawings or bitmap images, into three dimensional models, and a system and a method for distributing copyright protected data. Moreover, the invention relates to a computer-readable medium for implementing such systems on a computer network.

An increasing number of people use a computer and/or the internet when searching for a new home, i.e. an apartment or a house, and/or when shopping for home supplies, such as furniture, electronic products, windows, doors, art, paint, paintings, wallpaper, kitchens, baths, etc. But this kind of virtual shopping leaves one of the most important questions open: How will it look in real life? Pictures of home supplies are generally available and floor plans of houses and apartments are generally available. But studying a two dimensional floor plan of a house does not provide much impression of the interior of the house. And looking at a picture of a couch does not provide the answer of e.g. how it fits in the corner of the living room.

Digital distribution of copyright protected data is a complicated task. On the one hand distributors want the users to be able to easily access the data. On the other hand the distributors want to prevent the users from being able to duplicate, edit and/or re-distribute the data. And even with the best possible digital copyright protection the analog hole vulnerability exists: Due to the analogue nature of the human senses the digital information must be converted to a human-perceptible (analog) form. Subsequently it is a relatively simple matter to digitally recapture that analog reproduction in an unrestricted form, thereby circumventing the restrictions placed on copyrighted digitally-distributed data.

But for three dimensional representations or models this analog hole vulnerability does not exist. A three dimensional model shown on a computer screen is a result of a number of calculations in the computer processor and/or the graphics card. The three dimensional model shown on the computer screen creates a spatial interpretation in the human brain that makes it difficult to be copied to an analog medium making digital distribution of three dimensional models a subject of increasing interest. Viewing a three dimensional model on a computer screen is often an interactive process wherein the model is rotated or in the case of a walk through model, the user will move around inside the model. This interactivity makes copying of three dimensional models even more difficult. Thus, if the distributed three dimensional models are protected and/or encrypted, a secure way of distributing protected digital data is possible.

### SUMMARY OF THE INVENTION

Thus, an object of the invention is to provide spatial interpretations of buildings and/or houses for users not skilled in the art of design and to provide building and home models with three dimensional models of supplies, some of said supplies possibly copyright protected.

This is achieved by a system for converting a first digital representation of a graphical object defined in two dimensions, such as a floor plan of a building such as a house or an apartment, into a second digital representation of said graphical object, said second digital representation defined in three dimensions, said system comprising means for converting the first digital representation into a vector based representation by means of an computer implemented algorithm, and means for converting said vector based representation of the first digital representation into a three dimensional representation of the graphical object.

With the system according to the invention any user can convert a floor plan of a house or any other building into a three dimensional walkthrough model of the house or building. Alternatively, into a three dimentional model for manual navigation or pre-recorded flyby. By selecting a bitmap image, or capturing part of a bitmap image, the user can define a digital representation of e.g. the floor plan of a building. These bitmap images can e.g. be selected from the World Wide Web, i.e. the Internet, in an html format. A plurality of images can be found on the Internet, also floor plans of houses and buildings. Most real estate companies offer floor plans of houses and buildings that are for sale. By selecting the floor plans or just parts of these floor plans by using a pointing device such as a mouse or a touch screen, the user is very quickly provided with a starting point. By subsequent image analysis provided by a computer implemented algorithm in the system according to the invention, walls, rooms, partitions, doors, stairs, corners, windows and the like, can be identified in the digital representation of the floor plane. Thereby users, both experienced and inexperienced, can build a somewhat realistic walkthrough model of a house or a building or a room in short time with just a few clicks on the mouse.

The system according to the invention applies to anywhere a 3D model is applicable on the basis of 2D data, e.g. in any construction projects. Not just houses and buildings but also stadiums, roads, urban and infrastructure planning. Also visualisation of settings and scenes in movies and/or computer games can be realised by the system according to the invention.

Preferably, new users can be up and running with a realistic and yet edible 3D model within 10 minutes, or even within 5 minutes. In a preferred embodiment of the invention the capture process is initiated and provided by a “capture” button in the application. Subsequent to activating the “capture” button the user can select at least a part of a web page, a digital image, possibly scanned, or a digital representation from another application.

In another embodiment of the system according to the invention, the user can specify a two dimensional model of a house beginning from scratch, i.e. the first digital representation is not selected from another bitmap, but it is specified by the user. I.e. the floor plan of a house is defined by specifying the shape and dimension of the outer walls, partitions, floors, etc. In a further embodiment of the system according to the invention, the first digital representation is selected from at least one list or at least one database of generic digital representations, e.g. lists or databases of floor plans of houses and/or buildings. These lists and/or databases are provided to the user by the system according to the invention.

In one embodiment of the system according to the invention, the user can specify several floor levels in a building by either capturing a bitmap from the screen or loading a bitmap from a file or datasource.

In one embodiment of the system according to the invention, the user can combine the input from either screen capture of the bitmap, loading of the bitmap from file or specifying the layout of the floorplan via manual input.

In one embodiment of the invention the resulting three dimensional model is a walk-through model, e.g. with the possibility of having the experience of moving through the interior of a house, similar to the experience known from popular computer games like Quake and Doom.

Image processing can be divided into two different types: Time domain image processing and frequency domain image processing. In a preferred embodiment of the invention the image processing is provided in the time domain. In another embodiment of the invention the image processing is provided in the frequency domain and in yet another embodiment of the invention the image processing is provided in both the time domain and the frequency domain.

In a preferred embodiment of the invention the computer implemented algorithm providing the image analysis on the first digital representation comprises any of the steps of:
Identifying substantially all the lines, i.e. determining the exterior and interior walls and partitions, doors and the like.
Identifying, converting and/or removing text, preferably by use of optical character recognition (OCR) means.
Identifying the colour schemes, i.e. the background color, exterior and interior color, colors in different rooms, and the like.
Identifying objects such as furniture, floor patterns or the like, preferably by comparing said objects to generic versions of similar objects. Objects not relevant for further processing are preferably removed.
Identifying and preferably removing digital noise. Bitmap images originating from scanned documents often contain background noise.
Identifying floor plan objects such as walls, rooms, partitions, doors, stairs, corners, windows and the like.
Identifying scales, measurements and/or dimensions of said floor plan objects. The bitmap image possibly comprises information of scales and/or dimensions of the floor plan objects.

In a preferred embodiment of the invention the image analysis algorithm can be supplemented and assisted by manual input by the user. Subsequent to or during the computer implemented image analysis, the user provides manual analysis of the bitmap image, e.g. by manually selecting objects or shapes in the bitmap. The manual selection can be provided by a pointing device such as a computer mouse, a track ball, or the like. Objects such as text, furniture, floor patterns, colours, walls, partitions, doors, stairs, corners, windows, or the like, can be selected manually by the user and the type of or dimension of the objects can subsequently be determined by said user, and this information can subsequently be provided to the application running in the system according to the invention. The manual selection can be provided by pointing at the objects in the bitmap or by dragging or placing a polygon, such as a box, or a substantially circular or elliptical shape, around and/or over the objects by means of a computer pointing device.

### Administration of Protected Data

With the system according to the invention an advanced decorating, design and configuration tool is provided. A three dimensional walk though model of a house or a scene in general can be provided with a few clicks on the mouse. By furthermore providing three dimensional models of elements such as furniture, floor patterns, walls, partitions, doors, stairs, windows, surface texture, roofs, ceilings, designer products, kitchens and kitchen interior, bathrooms and bathroom interior, plants, garden elements, office elements, factory elements and the like, any user of the system according to the invention can play with various designs by adding and/or moving the elements made available to the user. These interior elements are represented by data files containing information of the three dimensional representation of said elements and/or surface material definition such as texture images. In a preferred embodiment of the system according to the invention, at least one of these data files is protected, e.g. protected from duplication, editing and/or redistribution in any form. It is an object of the invention to provide a system for distributing the protected data files such that access to the content of said data files is only provided by a system according to the invention.

This is achieved by a system for secure administration and/or provision of protected data files in a computer network, such as the Internet or a local LAN, said computer network comprising at least one server and a plurality of clients, said system comprising means for providing a loader module from at least one server to a client every time the client starts a new instance of the system, said loader module comprising:
a) means for providing data communication between the at least one server and said client,
b) means for validating protected files and unprotected files on the client by means of an hash function,
c) means for authenticating said loader module towards at least one server and subsequently providing at least one security code from said at least one server to the client to decrypt said protected files, and
d) means for encrypting and decrypting said protected files on the client and data communicated between the at least one server and said client.

In a further embodiment of the invention data are exchanged between the at least one server and at least one client by means of a data communication protocol and wherein said data communication protocol is continuously varied, preferably varied in a random manner.

In a further embodiment of the invention the data communication protocol is varied each time the at least one server provide said at least one security code from a server to a client, whereby data communication is provided through a unique data communication protocol.

In a further embodiment of the invention said loader module is different every time it is provided to a client, thereby making it difficult to attack and break the data protection provided by the loader module.

In a further embodiment of the invention a substantial amount of random data is integrated in the loader module each time said loader module is compiled on a server, whereby each compiled loader module is unique.

In a further embodiment of the invention a loader module is compiled on a server prior to said loader module is provided to a client, whereby a unique loader module is provided to each client.

In a further embodiment of the invention authentication of a client by a server is provided by means of a security code comprised in the loader module and/or by means of a message encrypted using a security code comprised in the loader module.

In a further embodiment of the invention the hash function is an SHA algorithm.

In a further embodiment of the invention the encryption and/or decryption algorithm is based ASE encryption.

In a further embodiment of the invention at least one security code is a password.

In a further embodiment of the invention no user login is required for a client to access at least one server.

In a further embodiment of the invention the loader module is exclusively loaded into non-volatile memory, such as the random access memory, at the client.

Yet another embodiment of the invention relates to a system for launching applications on a client, such as a computer, through a computer network, such as the Internet or a local LAN, said computer network comprising at least one master server and a plurality of 3^{rd} party servers and a plurality of clients, said system comprising means for a user, connected to and/or associated with a client, to approve certificates from one or more specific 3^{rd} party supplier, subsequently said 3^{rd} party suppliers will be able to provide applications to be launched on said users client, said system further comprising means for periodically communicating with the at least one master server to validate the certificates approved by said user.

In a further embodiment of the invention the at least one master server is managed by a master service provider and the 3^{rd} party servers are managed by other service providers.

A further embodiment of the invention comprises a web browser plugin, such as an ActiveX control or an npapi based plugin.

A further embodiment of the invention comprises a subsystem for updating the users client with new software components and data files when these components or files become available in a newer version.

A further embodiment of the invention comprises a subsystem for downloading software components and data files to the client, storing them exclusively in random access memory and using them from random access memory.

A further embodiment of the invention comprises a subsystem for launching software applications into a new process running on the client and being able to project the visual output of the newly launched application to a specific region on a client screen controlled by the system.

In a further embodiment of the invention it is possible to build managed code software applications to be run on several different operating system and/or hardware platforms without having to compile specific versions for the different varieties of operating systems and/or hardware platforms.

In a further embodiment of the invention it is possible for the 3^{rd} party supplier to provide new versions of an application and/or an entirely new application to a client without requiring the user to approve a new certificate from the said 3^{rd} party supplier.

A further embodiment of the invention provides any of the following steps when accepted by a user to run an application from a 3^{rd} party supplier on a client:
providing a certificate template from the at least one master server to the client,
providing a contract, such as a license agreement, for the user to accept, thereby establishing an agreement between the user and the 3^{rd} party service provider, said contract preferably comprised in said certificate template,
periodic validation of the 3^{rd} party supplier against the at least one master server,
providing the certificate from the at least one master server to the client, the certificate being encrypted with the master supplier private key and can be decrypted only with the master supplier public key, the certificate comprising a 3^{rd} party public key.
providing an encrypted app file, preferably an encrypted application .xml file, from the 3^{rd} party server to the client and subsequently decrypting the encrypted app file by means of the 3^{rd} party public key comprised in the certificate, said app file comprising information about application files on the 3rd party server,
providing application files from the 3^{rd} party server to the client based on the information comprised in the app file,
loading and running the application files from the 3^{rd} party server on the client.

In the following the abovementioned application may be referred to as the Roozz plugin.

In a further embodiment of the invention administration of protected data is provided by a system according to any of the listed embodiments.

The loader module provided by a server to a client in the system according to the invention, can be a dynamically loadable module or an executable, e.g. a dll or exe file. In the following said loader modules can be referred to as loader modules LM. Other files can be provided from at least one server to the plurality of clients and that might include other runtime loadable modules. In the following files provided to clients by a server in the system according to the invention will be referred to as client files. Application files, helper modules and data files are all part of the group of client files. Protected data files are files provided to the clients by at least one server wherein the content is protected and/or restricted from general access. The protection can be provided by at least one security code, such as a password or encryption key, and/or the content can be protected by means of encryption technology. If the content of a data files is encrypted, decryption technology is necessary to access said content. The content of protected data files can be source code, 3D models, copyright protected data, music, video and the like.

By the system according to the invention, distribution of protected data is turned upside down. Sensitive and/or valuable data can be distributed to a plurality of users without risk of losing control of the distribution of the content. Access to the data is controlled by means of the loader modules LM sent out to each client. Only the loader modules LM can provide a client access to the content of protected data files. Compared to known distribution methods of protected digital content an extra administrative layer is provided by means of the loader modules LM. And the loader modules are furthermore a dynamic administration tool, because they are unique for each session. I.e. administration of protected data files by the system according to the invention is developing over time by means of the development of the system files and the access to these files provided by the loader modules LM.

In one embodiment of the invention a loader module LM comprises a hash algorithm, minimum one security code. The hash algorithm, such as a checksum algorithm or a SHA algorithm, provides the option of obtaining a digital fingerprint of client files. Thereby files being part of the system according to the invention, but already present at a client computer, can be authenticated by the hash algorithm. If any of the files have been tampered with or in any way changed, a digital fingerprint provided by the hash algorithm and provided to the server will reveal if the files have been changed. In a preferred embodiment the server will automatically provide a new version to a client of any files that have been changed. Thereby the system is constructed to minimize the loss of protected data files, because if a cracker finds a hole in the system and subsequently changes any of the files comprised in the system, the hash algorithm comprised in the system will provide proof of the file change. Consequently, new versions of the data files protected by new security codes can be provided to the client.

Each LM running on the client must be identified and/or authenticated by a least one server in the system according to the invention. In a preferred embodiment the identification and/or authentication is a digital signature provided by the loader module LM sent to each client. A security code comprised in the loader module LM can provide access to the encrypted data structure provided to each client from at least one server.

In one embodiment of the system according to the invention, a plurality of loader modules LM exist and each loader module LM is different from all the others. I.e. each client will receive a unique loader module LM every time the application is started. The uniqueness ensures that it is very difficult to crack the system. In one embodiment of the system according to the invention, a new loader module LM is compiled at a server when a client request is received at said server. The hereby only just compiled loader module LM is subsequently provided to said client. In another embodiment of the system according to the invention, a plurality of different and unique loader modules LM have been compiled on at least one server. Upon request a client will receive one of these compiled loader modules LM. It is highly unlikely that a client subsequently will receive the same compiled loader module LM again.

A situation wherein the same loader module LM is sent to two or more clients might occur, e.g. if the number of requests to the server for a period exceed the servers ability to compile new versions of the loader modules LM, or if a stack of loader modules LM are reused another day. But to the specific client each received loader module LM is still unique because the system will ensure that the same loader module is never sent twice to the same client, e.g. by checking the IP number of each client.

Since each loader module LM that is provided to the clients are unique it is also possible to arrange the upper layer communication protocol, such that it is varied often in a random manner, such that it is impossible to know which protocol the loader module LM and the server will use to communicate in each session. This requires that the server is able to dynamically change the interface it uses to communicating with each unique loader module at runtime. This dynamic interface will then be able to communicate with the program comprised inside the unique loader module LM on one client computer. By changing both the loader module LM and part of the communication protocol for every session, it becomes impossible to create a static crack program, which can emulate the loader module LM and subsequent fool the server to believe that it is talking to a secure loader module LM on the client computer. With todays technology only static crack programs are known for cracking applications and providing unauthorized access to applications and associated data.

In one embodiment of a system according to the invention the loader module LM furthermore comprises a substantial amount of random data. The random data is integrated into the loader module LM each time it is compiled on the server. Said random data is contributing to making each compiled loader module LM unique. The random data will furthermore provide increased security against crackers and hackers trying to compare different versions of the loader module LM. In one embodiment of the invention the amount of random data is approximately 10 kb. In another embodiment of the system according to the invention, the amount of randomly generated data integrated into the loader module LM is less than 25 kb. In another embodiment of the system according to the invention, the amount of randomly generated data integrated into the loader module LM is more than 25 kb. In yet another embodiment of the system according to the invention, the amount of randomly generated data integrated into the loader module LM is more than 50 kb.

In one embodiment of a system according to the invention, at least one of the data files made available to the users is encrypted, preferably by a computer implemented encryption algorithm such as the Rijndael algorithm. Other applicable encryption algorithms could be ASE, DES, Triple DES, RC4, RC5 and RC6. Thereby it is controlled whether the content of the data files is available to the user. If the user is not provided with at least one security code to decrypt the data file, the content of said data file is inaccessible to said user. The security in the system is further improved if the data structures containing the security codes are also encrypted.

In one embodiment of a system according to the invention, the security codes are passwords, preferably long passwords containing more than 20 characters. These passwords can be randomly chosen by a computer implemented algorithm and can subsequently be stored in a secure database on at least one server in the system according to the invention.

In one embodiment of the system according to the invention, the loader module LM is provided from a server to a client through a secure network connection, such as an https web-service. Preferably, the loader module LM and the content of the data structures are only loaded into the random access memory of the clients, i.e. the content of these are not stored on the hard drive or any other similar medium. A decryption algorithm, such as a Rijndael algorithm, is preferably comprised in the loader module LM thereby providing access to data files and/or data structures that are encrypted by the corresponding encryption algorithm. In another embodiment of the invention a decryption algorithm is comprised in the application files already present at the client. Access to the data files is provided by the loader module LM activating said decryption algorithm.

In one embodiment of the system according to the invention, the digital fingerprint, i.e. a checksum, is returned from each client to the at least one server comprises the checksum of at least one of the protected data files and/or at least one of the client files with access to the protected data in the protected data files.

Activation of the system according to the invention is preferably provided by a small application provided by at least one server. This small application can be a plugin embedded in a web-browser (in the following called the Roozz plugin). Thereby activation of the system can comprise one or more of the steps of:
Visiting a web page on the Internet or a LAN.
Downloading the Roozz plugin to the client, if not already installed on the client machine.
Accepting and/or loading the Roozz plugin in the web-browser.
The Roozz plugin will subsequently activate the download of a loader module LM from a server to the client.

The downloaded loader module LM, only present in the RAM of the client, will subsequently verify that specific helper modules loaded on the client machine have not been tampered with by verifying the digital fingerprint of said helper modules. All data files will be decrypted and loaded into memory via a function call in the loader module LM.

In the preferred embodiment of the system according to the invention, the webbrowser plugin (Roozz plugin) is able to spawn a new process under the operating system and run the application inside this new process. In this case the loader module LM is an executable module (on Microsoft Windows this is know as a .exe module) The main windows of this newly spanned process is mapped over to the visible area of the Roozz plugin embedded in the webpage of the webbrowser. The result of this trick is that the user has the same user experience as if the loader module was programmed to be loaded into the webbrowsers own process as a dynamically loadable module (.dll on Microsoft Windows). However the execution model in the preferred implementation according to this invention has several advantages:
The loader module LM does not require any special browser interface thus any executable application can run as an embedded part of a webpage.
Few programmers have knowledge of how to program browser plugins, which can function with many different webbrowsers. But most programmers know how to program a standard executable application.
Since the loader module LM is executed in its own process there is no need to worry about multithreaded compliance of the application when several instances of the application are running in the same webpage or under several different webpages arranged under different tabwindows in the webbrowser
The Roozz plugin has a build in update system that automatically updates the software and content files on the client computer.

In todays webbrowser plugin paradigm the users are asked to manually confirm the installation of every webbrowser plugin because of security measures. Users are often hesitant to install such browser plugins because there is no system to automatically remove the plugin if it turns out to be unsafe. Because of this hesitation from the users companies incentive to release new innovative applications become greatly reduced. With the system according to the invention one plugin can be the host for a large number entirely different application and the Roozz plugin system can take over the security management of these hosted applications. The new security management system of the Roozz plugin has two major advantages:
The user can accept or reject all applications from a company or group in one simple action
The security management system can disable applications for all users if they are found to be malfunctioning or insecure.

It is known to be a quite complicated task to program cross platform applications. The invention of the Java programming language was an attempt to try to solve this problem, but Java has turned out to be either too slow or not fully cross platform compatible to solve this problem in many cases. This is especially true for 3D application.

In the preferred embodiment of the system according to the invention, the installation script of the Roozz plugin will check if the Dot Net framework (on Windows) and the Mono framework (on Linux and Mac) has already been install. If not it will install the Dot Net or Mono framework respectively. The result of this is that programmers can make Dot Net based applications for the system according to the invention, run on all three major operating system families. (Windows, Linux and Mac), with very little additional work. Because it is possible to write part of the application in unmanaged code and another part in managed code the system according to the invention has proven to run both fast and with minimal cross platform problems. Thus it is especially well suited for state of the art 3D applications.

The invention furthermore relates to methods corresponding to any of the listed systems.

The invention furthermore includes a computer program product having a computer readable medium, said computer program product comprising means for carrying out any of the listed methods.

### DETAILED DESCRIPTION OF THE INVENTION

In one embodiment of the system according to the invention, the first digital representation shall mean any two dimensional representation of a floorplan or image showing a layout, which can be shown on a computer monitor in a rasterized format such as a bitmap image. This invention is concerned with the technique to automatically or simi-automaitcally convert such a first digital representation into a second digital representation and further converting the second digital representation into a three dimensional representation. In this description of the invention the second digital representation shall mean a vectorized representation of a floorplan or image showing a layout and related information.

In the system according to the invention, means for secure administration of protected data files are provided. The following is a description of one embodiment of said system. The system is provided through at least one server and the system is preferably a web based application, i.e. it is activated through a web page available through a computer network such as the Internet or a LAN. In another embodiment of the invention the system is comprised in an application independent of any web browser. Connection to the server is provided through a network connection. A plurality of clients can access the system simultaneously through said network. Data files are provided to the clients from at least one server to the plurality of clients. In a preferred embodiment of the system said data files are encrypted, i.e. the content of the files are inaccessible for the clients unless they are provided with the correct security codes and/or the correct decryption algorithm. In a preferred embodiment of the system the data files are encrypted with an encryption algorithm such as the Rijndael algorithm.

Loader modules LM are provided from at least one of the servers to the plurality of clients. Said loader module LM can be a substantially small data file, preferably comprising a hash algorithm, such as the SHA hash function, for providing a digital fingerprint of any file and/or at least one security code. In a preferred embodiment of the system the file size of the loader module LM is less than 400 kb, even less than 300 kb and even less than 200 kb. Preferably the loader module LM furthermore comprises a substantial amount of random data. The random data is integrated into the loader module LM each time it is compiled on the server. Thereby the digital fingerprint of the loader module LM varies for each time it is compiled.

The loader modules LM provided to the clients subsequently authenticate it self to the server by providing an asymmetrically encrypted message, from the clients back to the at least one server. In another embodiment of the invention the loader module LM furthermore provides digital fingerprints of at least one encrypted data file present at each client from the client back to the at least one server. This is a safety inspection to ensure that none of the encrypted data files present at the clients have been tampered with. If any changes have been made to the encrypted data files at the clients, the digital fingerprint will provide the evidence. The encrypted authentication message sent back to the server ensures that the loader module LM is the right one.

Subsequently the server verifies the returned encrypted authentication message and/or digital fingerprints of the encrypted data files. If the digital fingerprints and encrypted authentication message are authenticated, the server will provide encrypted tables to each client, said encrypted tables comprising the random passwords for the specific encrypted data files that the client need access to. The encrypted password tables are decrypted by a master password provided by the loader module LM. Once the encrypted password tables are decrypted at each client, each encrypted data file can be decrypted by a password provided by the decrypted password table. In a preferred embodiment of the invention the loader module LM comprises the decryption algorithm, such as the Rijndael algorithm, used for decrypting the encrypted password table and the encrypted data files.

In one embodiment of the system according to the invention a plurality of loader modules LM are compiled at the at least one server. Each loader module LM is compiled containing a random password and a substantial amount of random data is comprised in each loader module LM, whereby the checksum of each compiled loader module LM is different. Thereby the same loader module LM is never sent to the same client twice and/or the same loader module LM is never sent to the same IP number twice. The random data comprised in each runtime module prevents a person with evil intentions to compare different loader modules LM to extract the security codes and/or the hash algorithm from the loader modules LM.

In a preferred embodiment of the invention the it is never know how many passwords are comprised in each loader module LM, and they are always stored in different locations in the client RAM, thereby increasing the security in the system according to the invention.

One application of the system according to the invention is distribution of content for three dimensional broadcasting applications. Live broadcasting in three dimensions requires distribution of a huge amount of data. Prior to the live broadcast three dimensional models and/or descriptions of relevant material could be distributed and/or provided to relevant clients and/or users and/or viewers. For instance when showing a live sports match 3D models comprising e.g. structural information of many details of the stadium could be distributed ahead of the match. During the match these structural details do not have to be provided and/or distributed to broadcast viewers, thereby avoiding sending a substantial amount of data. Also 3D models of e.g. players and/or spectators in the match can be distributed ahead of the game. By the system according to the invention the distribution of such 3D models is safe and access to the 3D content can be provided by distributing loader modules LM to potential broadcast viewers.

For the system according to the invention to be a successful platform for new state of the art applications it is important that:
Typical programmers find it easy to program new application on the system.
The system minimizes any overhead on CPU and GPU and bandwidth.
The end user can trust that the system is safe to install on their computer, without the risk of being attached by hackers.
The content providers can trust that copyright protected material in the system will not leak out.
Application suppliers can trust that their copyright protected application cannot be easily cracked and used for free.
Application suppliers can trust that their application cannot be use as a backdoor into client computers, thus giving them the responsibility for hacker attach on the clients computers.

In the system according to the invention the Roozz plugin allow the programmer to choose any programming language he wants. Roozz does not put any restrictions, interfaces or other requirements on the application programming paradigm, which means that the programmer can use his favourite programming language. This is not seen in any other similar system before. In addition the Roozz plugin take care of all the tedious stuff that many programmers find hard to solve such as:
Automatic application update when new versions are released
Automatic installation of required frameworks such as Mono and Dot Net.
Very simple to make cross platform applications based on managed code.

In the system according to the invention the Roozz plugin tries to minimize the CPU and GPU overhead by allowing users to write CPU and GPU intensive software components in low level and efficient languages, while at the same time allowing GUI and control software to be programmed in modern managed code programming languages. The bandwidth is also reduced in that files are only sent forth and back if they are not already cached on the destination computer. Furthermore only the difference between files is send in cases where this is known to reduce the bandwidth requirements. Bandwidth reduction is very important for mobile applications and in applications where the server must handle millions of users simultaneously. For the programmer to use all this building functionality of the system of the invention he only has to specify the list of files needed on the client computer to run the application. Then the system will automatically take care of all the distribution and installation on client computers including handling of cross platform configurations.

Because of the fear of hackers users are not likely to install software from unknown suppliers. For simple applications this can be solved by supplying a framework such as Flash Player or JavaScript or Microsoft Silverlight that only allow software programmers to do safe things on the client computer. The drawback of this method is that the framework must restrict what the programmer can do and in some examples the framework has a very high overhead, thus wasting CPU power, electrical power and bandwidth. Which ultimately result in a situation where it is not possible to build state of the art applications on those frameworks. The system according to the invention is trying to take the best of both worlds, free the programmer, remove any overhead and give the end user a security model which he can trust. The security model is that the end user must install a certificate for every 3^{rd} party supplier he trust when he want to run applications from that supplier the first time. Before the user installs the software he can see how many other users trust this supplier. The end user can specify how often he wants the Roozz framework to check with the master server if the given 3^{rd} party supplier is still considered safe by the collective community of users of that application. If someone finds that the application is unsafe and report it to the Roozz supplier, then the Roozz administrator will evaluate the problem and suspend the application from running on all client machines until it has been verified how the problem can best be solved. While the security layer provided by the Roozz plugin does not completely remove the security problems related to none restricted programming framework models, it gives the end user some tools to reduce the risk of a disaster.

Because of the integration of the Roozz plugin technology and the loader module technology content providers can use this system as a safe way to distribute copyright protected data to end users with out risk of theft.

Because the Roozz plugin technology uses a certificate security model+the hash function check on all files, 3^{rd} party suppliers does not have to worry that their software application can be infiltrated and used as an agent for hackers to attach all the client machines with their software application. Because the certificate guarantees that the Roozz plugin will only run or download files that are specified in the 3^{rd} party suppliers encrypted app .xml file on their own server. Thus it becomes much harder to spoof the client or the server to send some infected applications to the client computer than it would normally be when users download and install some application or plugin from the Internet.

### DESCRIPTION OF DRAWINGS

FIG. 1 is a schematic overview of one embodiment of a system according to the invention,

FIG. 2 is a flow chart illustrating one embodiment of the image processing algorithm,

FIG. 3 is a sequence diagram showing the process of how the Roozz plugin is installed and launched on the client computer and how the Roozz plugin manages to serve secure applications from a 3^{rd} party supplier to the client computer,

FIGS. 4 to 13 show different examples of floor plans of offices, houses, apartments and buildings.

FIG. 14 is a flow chart illustrating the initialization of the system on the client computer,

FIG. 15 is a schematic overview of the network structure on which the system according to the invention is implemented,

FIG. 16 is a table comparing the system according to the invention (Roozz plugin) to other similar technologies on the market today,

FIG. 17 is a flow chart illustrating one embodiment of the image processing algorithm,

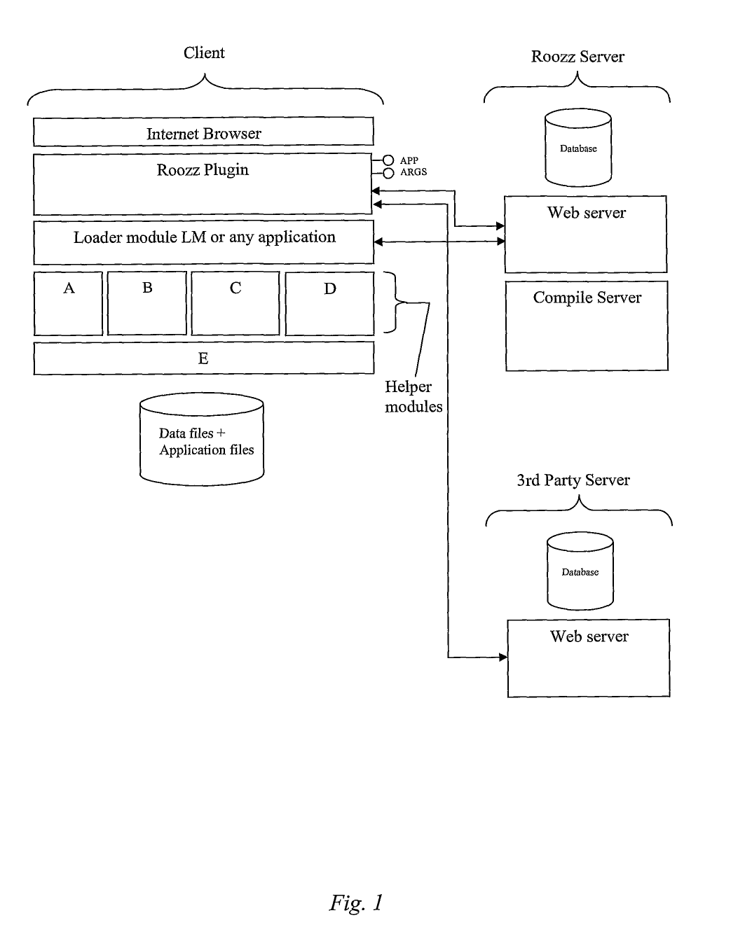

FIG. 1 is a schematic overview of one embodiment of a system according to the invention, illustrating the components on the client side and on the server side. The system according to the invention runs as an internet browser plugin. To install this Roozz plugin on the client computer requires the client user to accept the installation. This is only necessary the first time the user installs the software on a client computer. Thus, a Roozz plugin which seldom changes after it is installed the first time. This Roozz plugin can ask the user to accept the certificate for a given 3^{rd} party supplier and ask the Roozz server to generate the client-and-3^{rd}-party specific certificate, and the Roozz plugin can furthermore download the encrypted app configuration file from the certified server and further download and cache all the files required for that application to run. Finally it can spawn up a new process and start the application according to the input parameters and settings in the app configuration file. Subsequent, if the application is based on a new loader module LM from a server this will be the application to load in the new process.

The loader module LM is always new from the server, thus new functionality is easily inserted into the loader module LM. The Roozz plugin as well as the loader module LM can also provide download of new versions of helper modules (also referred to as utility modules) A, B, C, D and/or E, or even download additional helper modules and/or download of data files and/or application files, or new versions thereof. Typically in a system like this, the helper modules are rather big or there are many of them. Thus to save bandwidth they shall only be downloaded to the client computer once. Helper and utility modules can be provided to the client by at least one server, but can also be internal files from the client operating system, e.g. library files such as dll files and/or directX files (in a Microsoft Windows environment).

The Roozz server comprises a web server for communication with the Roozz plugin and loader module LM on the client side. The web server also provides the clients access to new data files. The server furthermore preferably comprises a compile service continuously compiling new and unique versions of the loader module LM. Preferably the server at all time comprises more than 1000 different versions of the loader module LM and can thereby ensure that the same version of a loader module LM is never sent to the same client twice. On the server side the system allows heavy clustering to deal with a high number of concurrent users.

The system according to the invention also allow for any 3^{rd} party server to provide application files or content data files for the system. Specifically any 3^{rd} party Server shall provide minimum one app configuration file which is encrypted with asymmetric encryption using the 3^{rd} party private key. The third party server may also provide access to a database or other server functionality. When the Roozz plugin is asked to load a 3^{rd} party application, it will first verify if the certificate from that 3^{rd} party is installed on the client computer. If this is not the case, then the Roozz plugin will ask the user of the client computer to accept or reject the 3^{rd} party certificate and subsequently configure the client computer for it accordingly.

Strengths of the illustrated system in FIG. 1:
Only very few persons have access to the source code—the algorithm which generate the loader module LM.
Software developers only have access to debugging using data files that are cleared for unsafe debugging.
Data file passwords are stored on the database and only a few trusted employees have access to the database content.
3^{rd} party suppliers can supply application and content data to the system without weakening the system security.

The encrypted data files are typically cached and/or stored on the hard drive of the client. Thereby the encrypted data files are not viewable or editable on the client side when the application in the system according to the invention is not running. The password to access the encrypted data is only present at the client side when the application is running and the loader module LM is present in the RAM of the client. Thereby copyright protected content can be present on the client side without the possibility of unauthorized access. Download time is also saved, because copyright protected content does not have to be downloaded from the server each time the application is running. It is already present at the client side in the encrypted data files.

In a preferred embodiment of the invention no user login is required, neither on the client side nor on the server side.

In a preferred embodiment of the system according to the invention, updated versions of helper modules, application, library and/or data files are automatically provided to the client through the network.

### Image Processin Algorithm

Creating an algorithm for converting a bitmap image, such as a floor plan, into a vector based representation of said bitmap image is not a trivial task. Especially if the conversion quality must be high on a large variety of floor plan drawings. Some floor plans have text on the drawing, and the text may even cross the walls. Some floor plans have furniture added to the drawings. Some floor plans are scanned documents introducing a lot of noise in the bitmap image. To make a system that solves all these problems is very difficult and will include known image processing algorithms for detecting lines, edges, patterns, text, and the like.

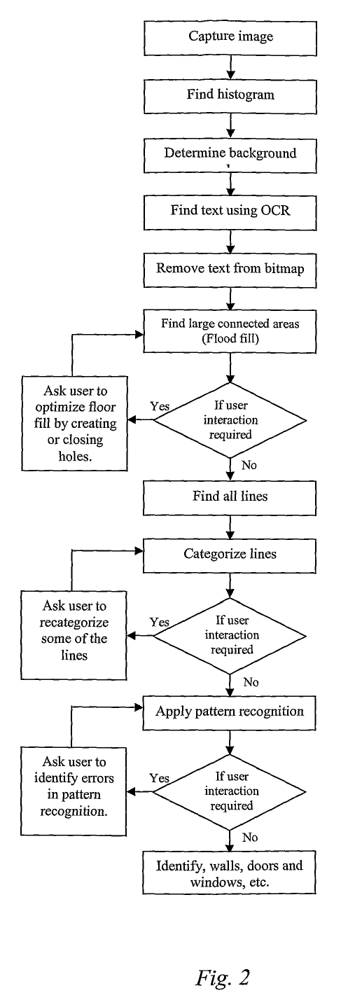

FIG. 2 is a flow chart illustrating the image processing algorithm in one embodiment of the system according to the invention, wherein the user might interact with the image processing algorithm:
The image is captured by capture means, e.g. by letting the user drag a box in a web page.
The histogram of colors is determined.
The background color or colors are determined on the basis of peaks in the histogram.
Find text using OCR algorithms.
The found text is removed from the bitmap and new bitmaps are inserted where the found text is removed.
Find rooms (areas) that are connected, by flood filling background color. Start from the outside (at the edge of the bitmap).
Users are possibly asked to draw small lines to close holes where the flood fill flow from one room to another because of errors in the bitmap.
Find all lines in the drawing, categorize them by color, width and length.
Users are possibly shown all or some of the line categories and subsequently asked to “turn off” some of the line categories to make the algorithm more successful.
Use pattern recognition to find pictograms of doors, windows, furniture, arrows and the like, that are shown several times in the bitmap or are listed in a library or database of standard pictograms.
Users are possibly asked to draw a polygon around objects that should be removed from the bitmap.

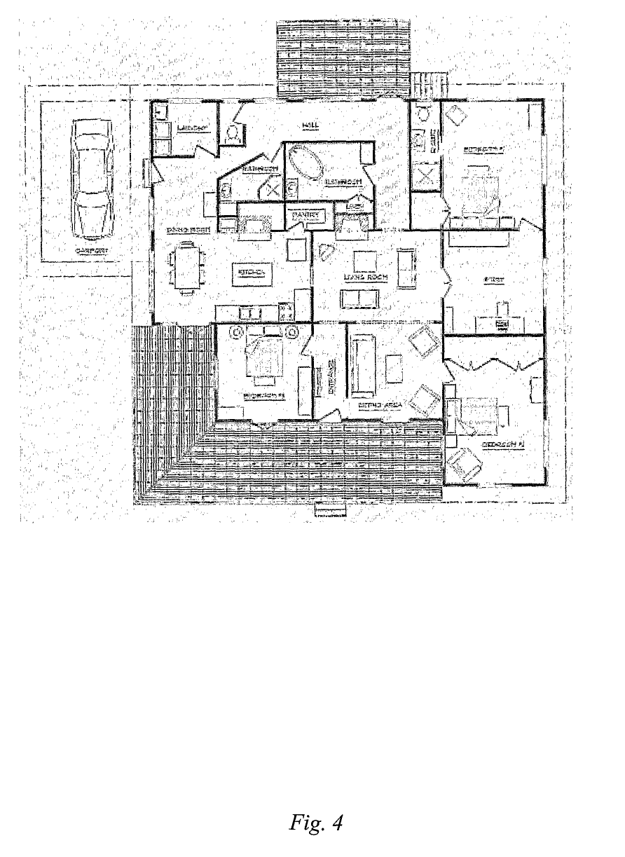

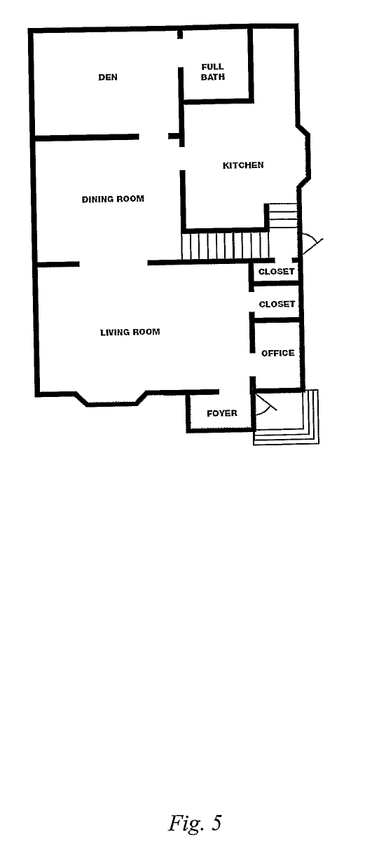

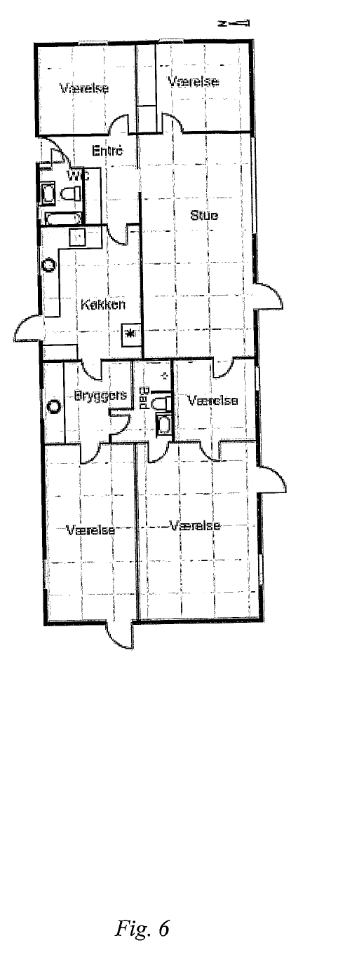

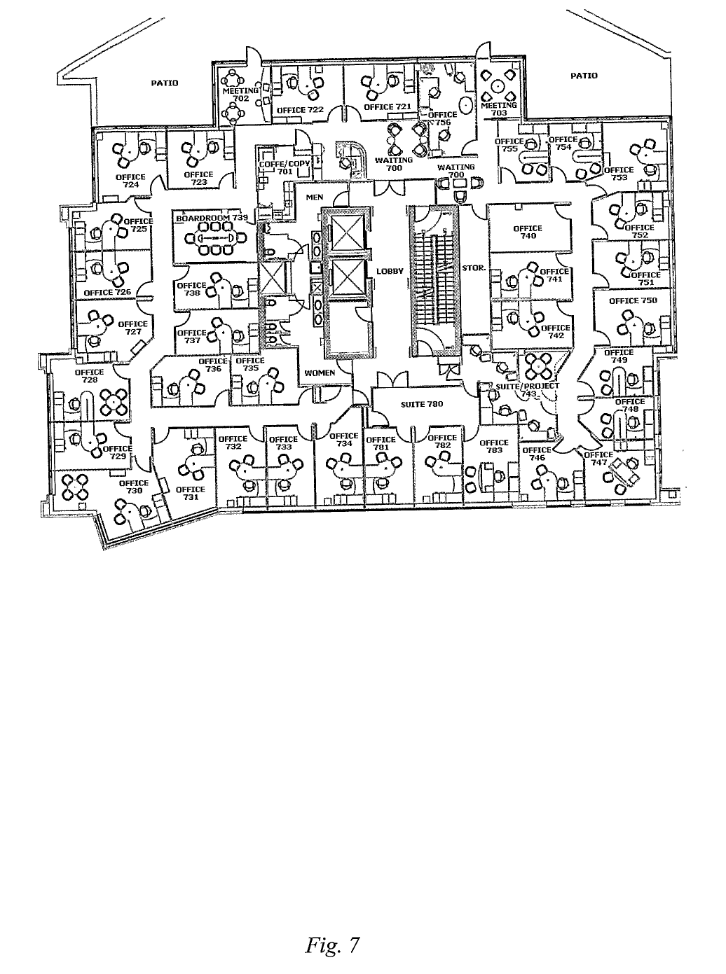

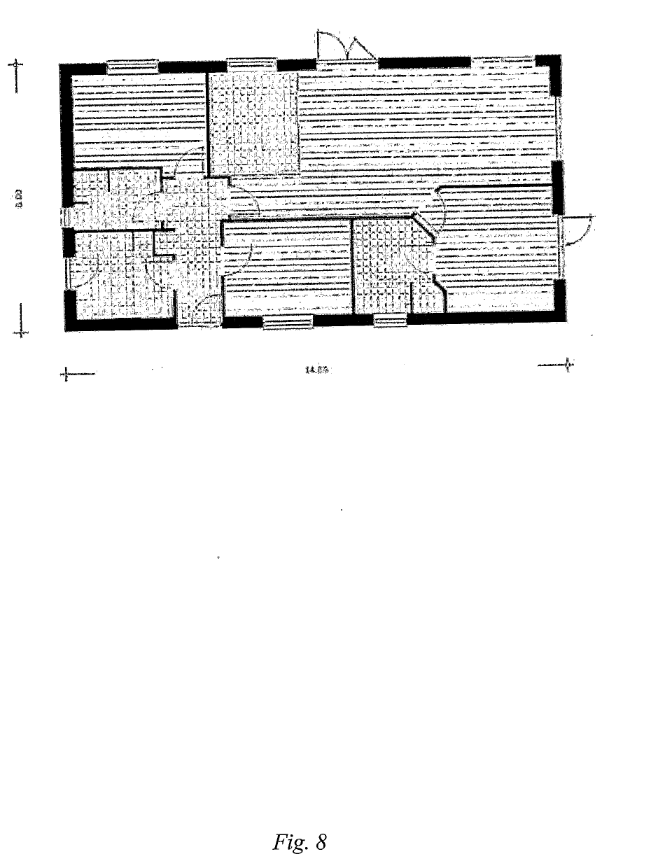

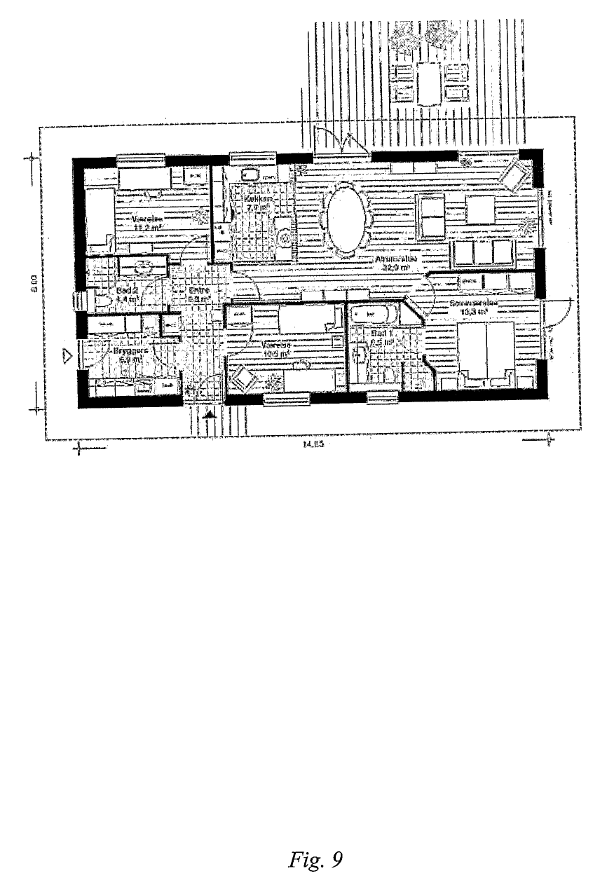

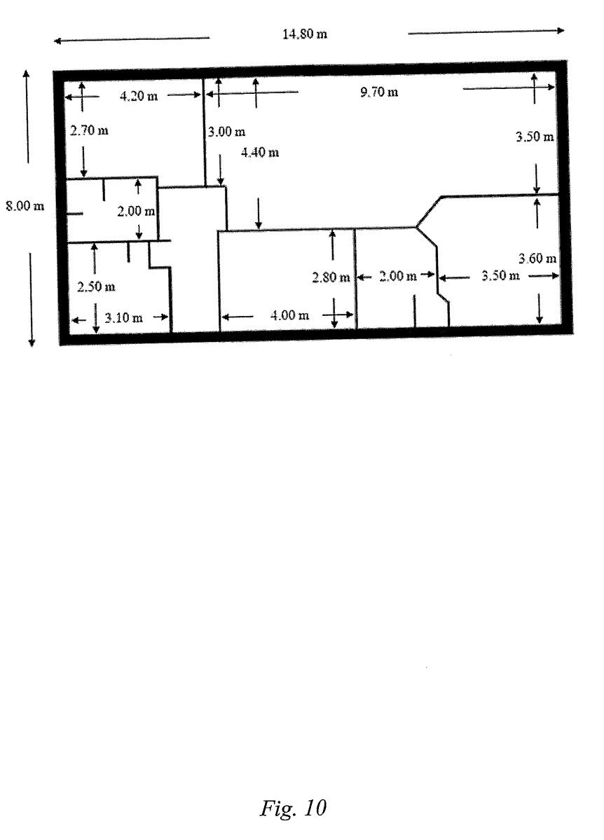

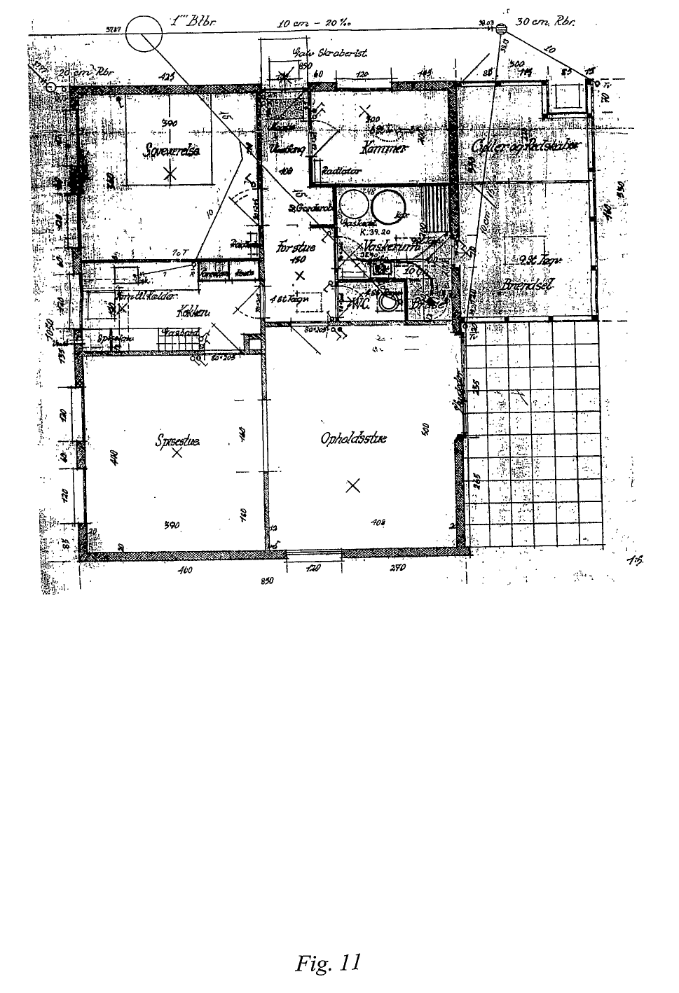

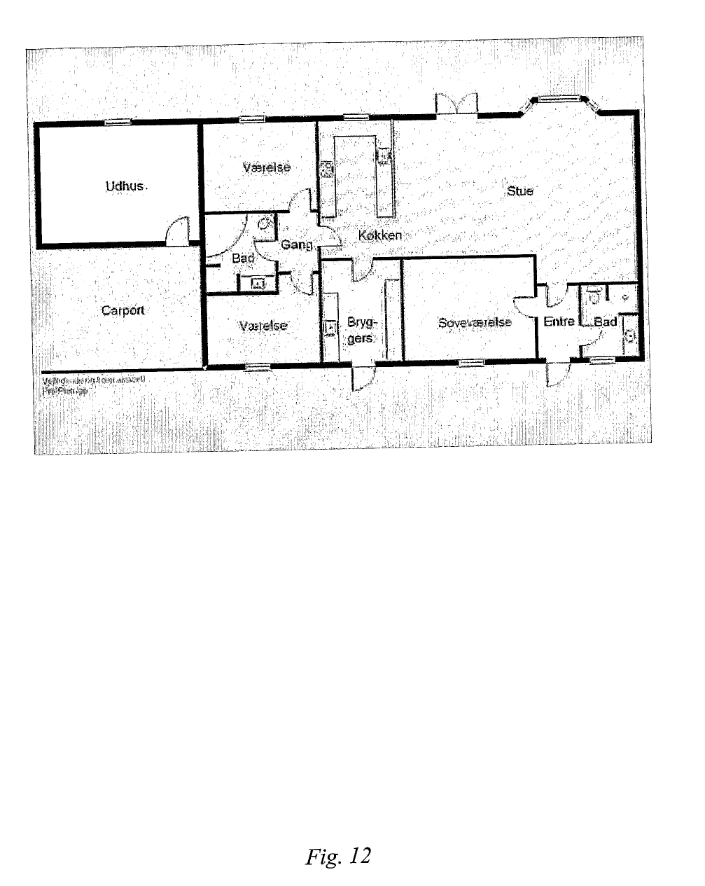

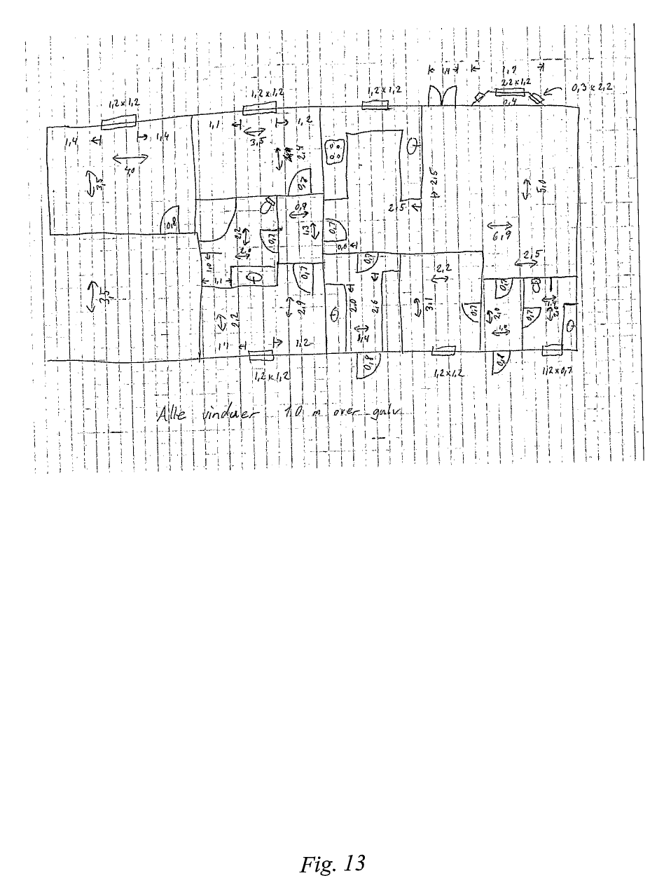

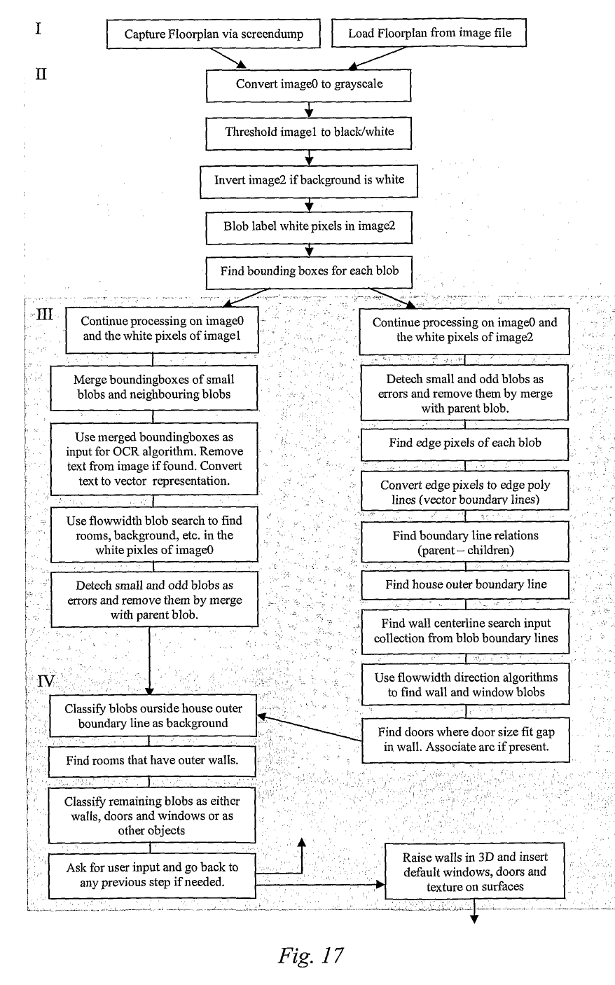

FIGS. 4 to 13 show different examples of floor plans of offices, houses, apartments and buildings to illustrate the necessary complexity of the image processing algorithm. The figures contain text and vary from simple line drawings (FIG. 5 and FIG. 10), to complex office layouts (FIG. 7), floor plans with numerous different patterns and furniture (FIGS. 4, 8 and 9) and hand drawn scanned images containing background image noise (FIGS. 12 and 13). Also stairs, scales, measurement and large variations in the pictograms symbolizing windows and doors are illustrated in the figures.
FIG. 17 shows a flowchart illustrating one embodiment of the image processing algorithm according to the invention. FIG. 17 is grouped into 4 sections:
   The top section I (yellow) show two possible sources for the input image. Either the user can capture the floorplan image from somewhere on the computer screen, or else the user can load the input image from a file.
   The second section II (green) show the first 5 steps in the image processing algorithm. First the input image is converted to greyscale, then a threahold filter is applied to map the greyscale image into a black and white image. If the black and white image has white as the background color then the black and white image is inverted in the third step. In the forth step a blob filer is applied to all the white pixels in the image, at this point the white pixels are all the walls and lines in the image. In the fifth step bounding boxes are found for each blob that was found in step four.
   The third section III (red) show 14 steps organized into two columns. The image processing in each of the columns can be carried out in parallel. Please note that the algorithm require that both columns are processed before the algorithm continues to the forth section IV (blue). The left column is concerned with the processing of the background pixels, this is the pixels that was black in step four of the second section, in the following it is referred to as the background processing or just BP. The right column is concerned with the processing of the pixels that was white in step four of the second section, in the following it is referred to as the foreground processing or just FP. Please refer to the explanation below of some of these steps.
   The forth section IV (blue) show 5 steps which summarizes the final steps of the algorithm. Steps in this section operate on vectorized data which is output from the steps in the third section (red). The overall purpose of the steps in this section is to classify the found objects correctly. In the forth step in this section users can give use input to correct the classification by removing, adding or correcting some classification. Here the user can also correct the measurements on the detected floorplan. Depending on the user action the algorithm will jump back to one of the previous steps and reprocess the floorplan detection. In the final step of this section the vectorized model of the floorplan in raised into 3D and default 3D models of doors and windows are inserted in the 3D model of the house on the positions where they were found in the floorplan. Finally default textures are added to the surfaces: Interior floor, interior walls, exterior walls, exterior ground surface, interior ceiling texture and exterior roof texture.
One central part of the image processing algorithm used in the invention is the flow width blob finding algorithm. It only allows growing the bolb in a given direction if the blob has a minimum width of some fixed value. This value is called the flowwidth. And it only continue to grow as long as the neighbour pixels are the same color as the originating pixel plus/minus some allowed offset The flow width blob finding algorithm comes in three variations:
   The basic form which grow a blob starting from one pixel and grow in all directions with a minimum flow width.
   The direction oriented form, which grow a blob starting from one pixel and grow in two directions along a line or curve.
   The shape oriented form, which grow the blob starting from one pixel and grow the blob in all directions as long as the overall shape of the blob is retained. The shape could for example be a rectangle or a circle.

This method is very good at detecting pixels that belong to a line or curve of a give width, because the flow width algorithm is started with a large flow width and then the flow width is decreased gradually until all lines are detected. For the two last forms of flow width algorithm it is very easy to convert the detected blob into a vector based description.

### The Roozz Plugin

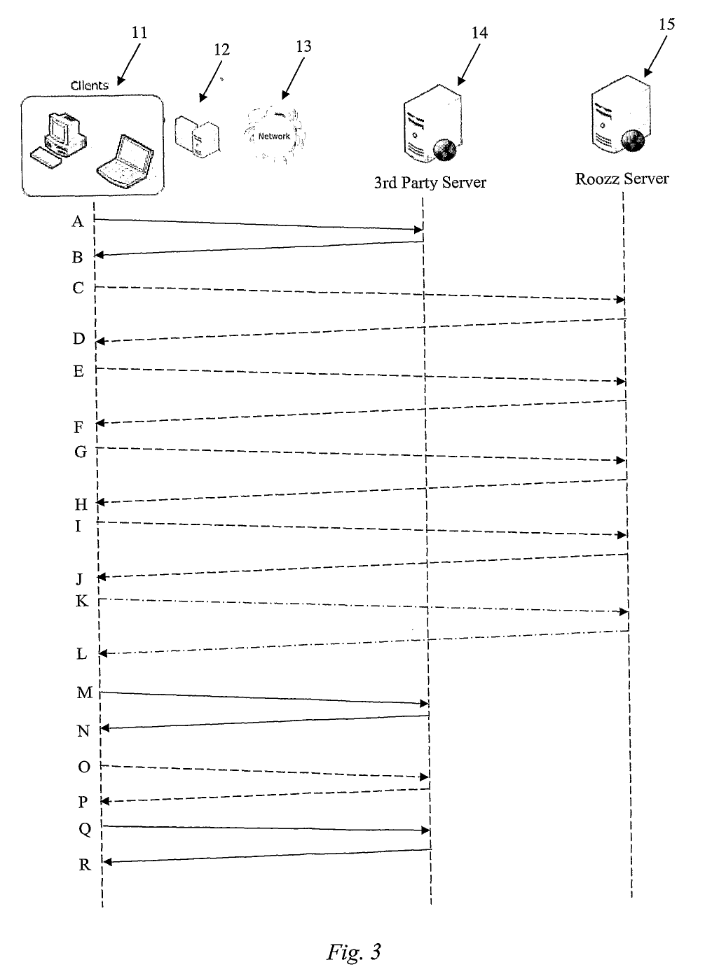

With reference to the numerals in FIG. 3 the following is a description of the sequence diagram where one client 11 requesting from one 3^{rd} Party Server 14 and one Roozz Server 15 the application in one embodiment of the system according to the invention, and how the system subsequently grants a user/client access to protected data files. Each of the following items represents the annotated action in FIG. 3, symbolized by arrows either between the client 11 and the 3^{rd} Party Server 14 or Roozz Server 15 through the network 13 and an optional firewall 12, when the plugin has not already been installed on the client computer. Arrows with a full line show requests that are required every time the application is started. Arrows with dash-dot line show requests that are required for blacklisting check:
A. The client 11 requests a webpage from the 3^{rd} Party Server 14. The client 11 and the 3^{rd} Party Server 14 are connected through a computer network 13 such as the Internet or a LAN.
B. The 3^{rd} Party Server 14 returns the HTML page, including graphics, javascript to the client 11.
C. When the browser notice that the Roozz plugin is not installed on the client computer the javascript will request an install page from the Roozz Server 15. If the Roozz plugin had already been installed on the client computer 11 we could skip steps C, D, E and F
D. The Roozz Server 15 returns the HTML page, including graphics, javascript. This page will be shown in the area where the Roozz plugin would otherwise have been shown inside the webbrowser on the client 11.
E. The user can click a link to download and install the Roozz plugin on his computer and the request is send from the client 11 to the Roozz Server 15.
F. The install package is downloaded from the Roozz Server and the user installs the plugin on his computer 11.
   During the installation process he must accept the License Agreement for the Roozz plugin. If required the Dot Net framework or MONO framework is also downloaded and installed during this step. After the installation of the Roozz plugin is complete the javascript make the client webbrowser reload the HTML page and step A+B are executed again.
G. When the Roozz plugin is loaded into the webbrowser on the client 11 it reads two parameters (APP and ARGS) from the HTML code. The APP parameter is an URL to an encrypted app .xml file on the 3^{rd} Party Server 14. Then the Roozz plugin checks if the certificate for the 3^{rd} Party Server is already saved on the client computer 11. First time this will not be the case and the Roozz plugin will download a CertificateTemplate from the Roozz server 15. (If the certificate was already saved on the client computer in the same directory as the Roozz plugin is installed, then we can skip communication in step G and H.)
H. The CertificateTemplate is returned from the Roozz Server 15 to the client 11. The CertificateTemplate can contain a LicenseAgreement from the 3^{rd} Party and some InstallPaths. User is asked to accept the license agreement and asked how often he want to check certificate for blacklisting (default value is one time per day). If the CertificateTemplate include InstallPaths then the user is asked to provide the correct path for these on his computer 11 or leave them blank.
I. These settings are sent to the Roozz Server 15 where it is encrypted with the Roozz private key.
J. The Roozz server 15 will return the requested certificate if available. (The certificate will only be available if paid for and not blacklisted for security reasons).
K. The Roozz plugin will check if the certificate expire date has been passed. If yes it will download a new certificate from the Roozz Server 15 without asking the user. (the old certificate is send to create the new certificate)
L. A new valid certificate is returned from Roozz Server 15 to the client 11 and the old certificate on the disk is overwritten with the new one.
M. Next the plugin downloads the encrypted app .xml file from the URL given by the combination of the 3^{rd} Party Server name in the certificate and the APP input parameter.
N. The returned app .xml file is decrypted with the public key in the certificate and the Roozz plugin can find information about, which files to download for the application, hash check sums for those files and action to be taken on these files when downloaded.
O. The Roozz plugin send download requests for the files listed in the app .xml file if they are not already cached on the local harddrive. The check is a combination of filename, filesize and SHA checksum. All must be correct, otherwise the file is downloaded again from the 3^{rd} Party Server 14 and overwritten on the client 11 harddrive.
P. The 3^{rd} Party Server 14 will send the requested files to the client 11 and the Roozz plugin will take the appropriate action on the files after they are downloaded. It most cases they will be saved to the local harddrive and loaded into memory. The application is now started in a new process and the main windows handle is set to the Roozz plugin area inside the webpage in the webbrowser on the client 11. If the app xml file includes a loader module LM then this will not be saved to any disk drive and it will be loaded into random access memory of the new process on the client 11 and will start to run the actual application from here.
Q. Subsequently the necessary files are loaded and authenticated with respect to file size and/or digital fingerprint by means of a hash algorithm in the loader module LM. The loader module LM at the client 11 side requests the 3^{rd} Party Server 14 for a data structure comprising a table of passwords for the protected data files the corresponding client 11 has access to.
R. At the 3^{rd} Party Server 14 side, said server 14 encrypts the requested password data structure by an encryption algorithm, such as the Rijndael algorithm. The encrypted data structure is subsequently sent to the client 11. At the client 11 side the loader module LM checks if the data files corresponding to the passwords in the password data structure are already cached on the client 11 hard drive. The encrypted data files at the client 11 are decrypted using the passwords from the password data structure provided by the server 14 and loaded into the random access memory of the client 11. The application files embedded at the client 11 can subsequently access the decrypted content of the previously encrypted data files, said decrypted content only present in the RAM of the client 11.

The described example illustrates the process when only one client 11 and one 3^{rd} Party Server 14 are involved. A plurality of clients 11 can access the same 3^{rd} Party Server 14 simultaneously or a plurality of clients 11 can access several 3^{rd} Party Servers 14 simultaneously. Even a plurality of concurrent instances of the application on each client 11 can be provided by the system according to the invention. The order of the sequence in the above example can be swapped and the system according to the invention may still provide a safe method of distributing protected data.

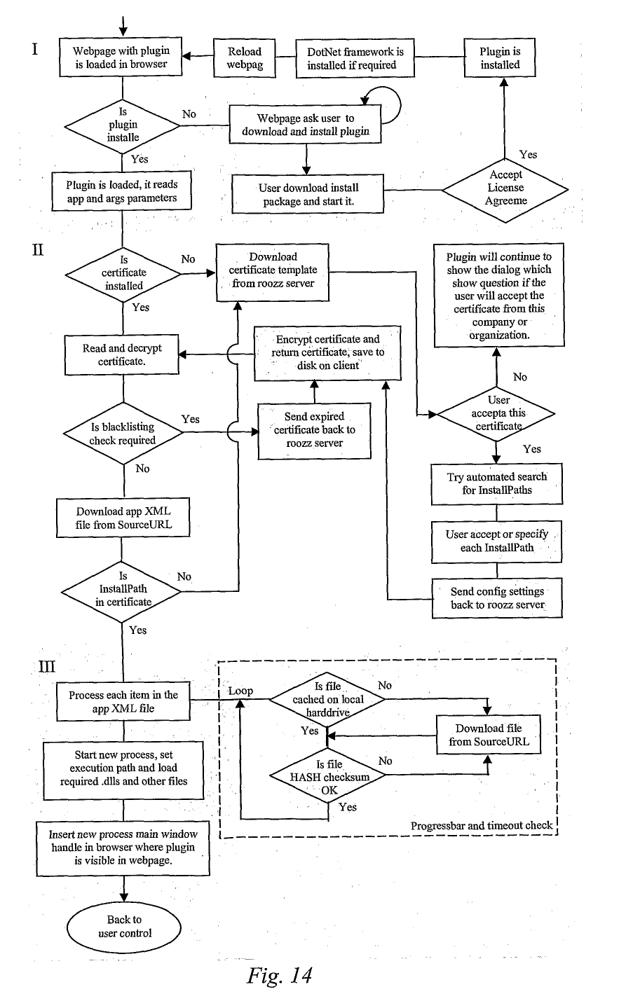

FIG. 14 show a flow chart illustrating the initialization of the system on the client computer. The process execution in FIG. 14 is very closely related to the sequence diagram show in FIG. 3. FIG. 14 is grouped in 3 sections:
The top section (I) show the flow chart of the process that takes place when the Roozz plugin is installed on the client computer the first time. This process is identical to the process when any other browser plugin is installed on the client computer. The boxes (gray) to the right of the left most column, are only visited the very first time the plugin is installed on the client computer.
The middle section (II) show the flow chart of the process that takes place when the certificate for the 3^{rd} Party Server is loaded into the Roozz plugin and the app xml file is downloaded from the 3^{rd} Party Server and loaded into the Roozz Plugin. The boxes (gray) to the right of the left most column, are only visited when the certificate is accepted by the client user or when it is upgraded with a new InstallPath. The process in this section is what makes the system according to the invention different from other browser plugin systems.
The buttom section (III) shows the flow chart of the process that take care of downloading or updating application executable files or content files for the specified application. This section is also responsible for spawning up a new process and load the application executable file (e.g. the Loader Module LM) into it. The boxes (gray) to the right of the left most column in this section are only visited if some of the files needed for the application (as specified in the app xml) are not already cached on the local computer.

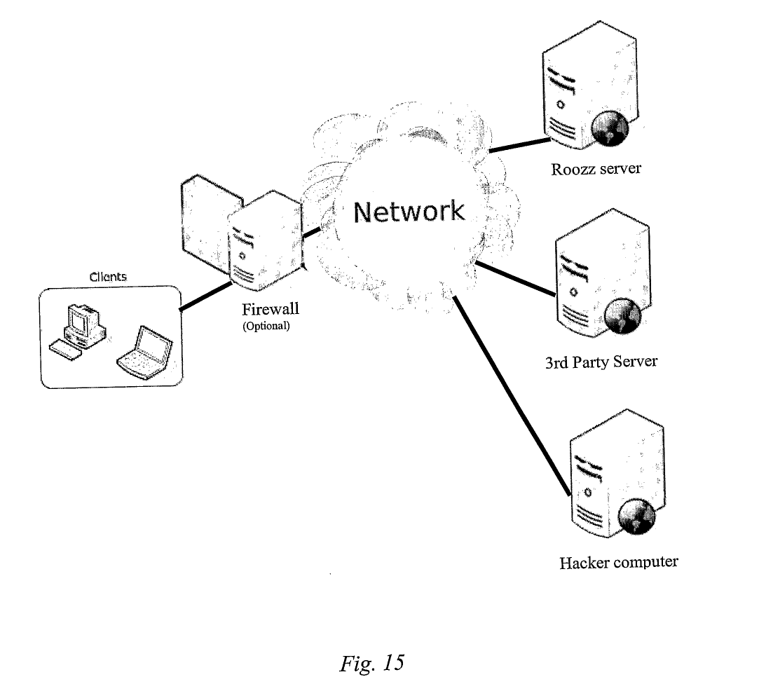

FIG. 15 shows the topology of the underlying network configuration on which the system according to the invention is most likely to run upon. This figure only show one instance of each item, (Client, Firewall, Roozz server, 3^{rd} Party Server and Hacker) but in most cases the network will connect to several instances of each item. The Hacker computer is not an intented part of the system, but the core purpose of the system according to the invention is to avoid attachs from Hackers and Crackers who want to either harm the client computer or want to use applications or application data in an illegal manner or even just be an agent to help others to do so.

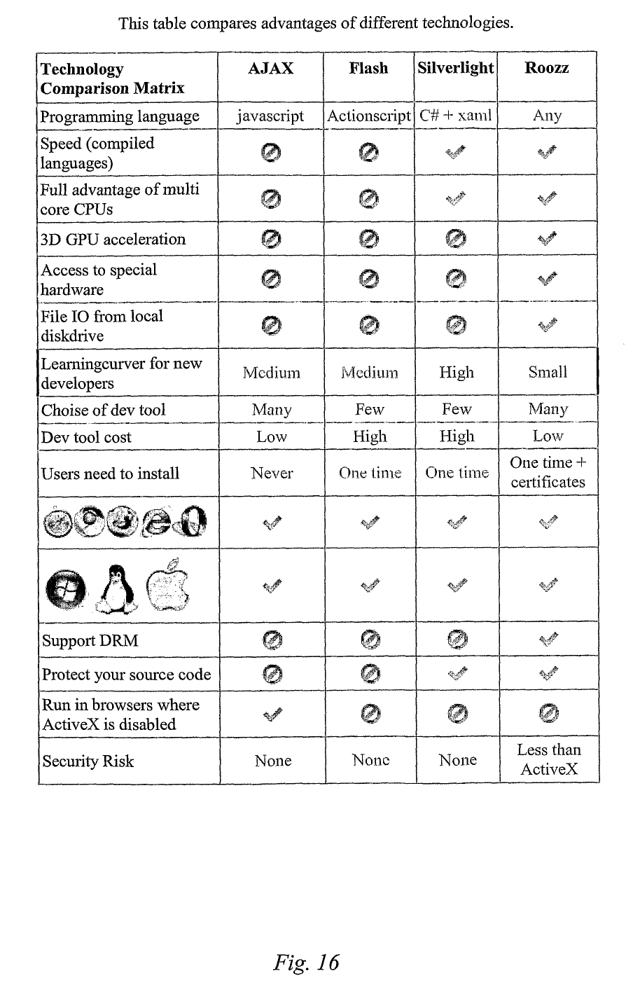

FIG. 16 shows a table comparing the system according to the invention (Roozz plugin) to other similar technologies on the market today. The table lists a number of properties of such technologies and summarizes the answer in the 4 columns on the right. AJAX is short for “asynchronous JavaScript and XML”. Flash is short for Adobe Flash Player 9 and the related actionscript. Silverlight is short for Microsoft Silverlight 2. Roozz is short for one embodiment of the system according to the invention. In row 11 the table show 5 icons of the current most popular webbrowsers: Appel Safari, Google Crome, Mozilla FireFox, Microsoft Internet Explore and Opera.

### Further Details of One Embodiment of the System According to the Invention

One embodiment of the system according to the invention ensures that the content of 3D data files and the content of other data files, cached on client computers, can not be stolen. The objective is to be able to cache and view protected data, such as copyright protected data, on the client computer, and at the same time protect the data from being stolen. In short: Enable try before you buy.

Requirements to the system:
To save bandwidth and reduce the time users wait on application response, encrypted data files used by the system on the client computer are cached on the client computer.
The system comprising software and data files can be used for free or for a small fee. Exporting files outside the application requires a larger fee. The user must be unable to access the content of the cached files on his computer.
The client computers must be able to download data files without identifying themselves, i.e. login is not necessary.
The caching system on the client computer must be able to check for updated versions of the data files on the server and download the data files again if they have changed on the server
Untrusted software developers must be able to access the source code of the client application. And they must be able to debug the application without introducing a risk that their knowledge can be used to break the system.
The system must be safe against attacks even from persons with evil intentions that know nearly all details about the system.
The client application can be comprised of Open Source software without making the system valuable to attack.
New versions of the client software are often and automatically updated on the client computer without user interaction. It is also required that a cracker cannot obtain the necessary information to break the system by comparing several different releases of the system.
The system must be able to scale to a very large number of concurrent users and provide several instances of the application running on the client computer at the same time.
Data files are downloaded as separate encrypted files from the server to the client and can be stored on the client harddisk. The Rijndael encryption algorithm is preferably used, but other encryption algorithms could also be used.
Each of the data files are encrypted with a long random password which is stored in a protected database on the server or several distributed servers.
When the application is started on the client computer, a data structure is downloaded comprising all the passwords for each of the encrypted data files needed for the current purpose. This password table is also encrypted using an encryption algorithm, thus a master password is needed on the client side to be able to decrypt the password table and hence decrypt the data files cached on the client computer.
The server must ensure that the software on the client computer which decrypts the data files and the password table has not been infiltrated, e.g. infiltrated such that the passwords or the decrypted data files can be saved to disk.
The system must be constructed such that the trusted software on the client, which receives the master password to decrypt the password table, is very difficult to crack and thereby get access to the master password in memory.

A small trusted loader module LM is downloaded to the client from the server every time the application starts up on the client computer. This loader module LM will hold an unknown number of master passwords and a hashing algorithm. The hashing algorithm is used to validate all of the application files on the client computer to ensure that they have not been tampered with. File size, digital fingerprint, such as hash checksum, and an authentication string is sent back to the server and verified before the encrypted password table is send out to the client. A master password is used to decrypt the password table in memory.

Requirements to the loader module LM:
The file size shall preferably be less that 200 kb for providing fast download to the clients. Bandwidth is expected to rise in the future whereupon the file size of the loader module might increase in future developments and releases of the system, because with increased bandwidth fast download might still be provided for file sizes of several megabytes.
A new version of the loader module LM has to be compiled on the server each time the client starts the application. At least the chance that users will receive the same loader module LM twice has to be very, very small.
The loader modules LM can be compiled ahead of time and queued on the server before they are requested by new client applications that are initiated.
The loader module LM must store one or several master passwords in different locations in memory when started on the client computer, to avoid a person with evil intentions would know where in memory to look for the master passwords.
The loader module LM must have a fair amount of random data mixed in with the master passwords to avoid that a person with evil intentions could just compare several of the loader modules LM and find out what is hash algorithm code and what is passwords.
The loader module LM shall never be stored on the client computer hard disk. It shall be downloaded through a secure channel, e.g. through an https web service, and subsequently loaded directly into memory (RAM).
If the decryption algorithm, such as the Rijndael decryption algorithm, can be included in the loader module LM then the system can be made even safer, because a person with evil intentions cannot use prior knowledge of the decryption method fingerprint of the encryption algorithm module to know where in memory to set runtime breakpoints and search the stack for passwords.

When the loader module LM or a helper module decrypts the data files, the decrypted content is only stored in memory, i.e. never saved to disk or a similar storage medium, and these memory buffers are then passed down into the helper modules which need access to the protected data.

Helper modules which manipulate protected data from encrypted data files have to comply with the check provided by the hash algorithm. Simple helper modules, which do not get access to protected data, do not have to be verified by the hash algorithm before they are loaded.

The only parameters that have to be kept secret in this system are the passwords of all the data files in the database on the server plus the method of how the loader module LM is created on the compilation server. Everyone can have full access to all other details of the system without introducing risk of theft.

Even open source client application modules are no problem. Because a company can review the source and if they trust the sources they can compile a release version of the module and note the file size and digital fingerprint in the database. From then on the loader module LM will be allowed to load these modules on the client side too.

Third parties can even make close source applications for the client and allow them to manipulate data files, as long as they only operate on data files from the same third party or on data files which have already been paid for by the client user. Since viewing of 3D data is an interactive process the analog-hole copy protection problem does not exist in this system.

In case a person with evil intentions, such as a cracker, searches memory while the program is running and finds the password to decrypt a single data file, he can then subsequently publish this password and all users can potentially decrypt this data file. But if this becomes known, that particular data file will be encrypted on the server with a new password and all clients will automatically download the new file next time they login. For very expensive data files or data files with high risk of theft, the data file can be encrypted with a new password weekly or daily. This will then increase bandwidth consumption, but that is the added cost of better protection.

### Requirements to the Roozz Plugin

The Roozz plugin shall be more secure than a standard ActiveX or npapi (Netscape Plugin API) webbrowser plugin.
The Roozz plugin shall be able to execute programs embedded in the webpage and still be able to harvest the full processing power of the CPU and GPU.
The Roozz plugin shall remove the need to program using multithreading techniques when creating applications that are intended to run in parallel in the same browser.
The Roozz plugin shall allow the programmer to give input parameters to the application.
The Roozz plugin shall be able to update applications and data files on the client computer automatically and with minimized bandwidth requirements.
The Roozz plugin shall be able to run new programs that are created after the plugin has been installed on the client computer.
The Roozz plugin shall allow the programmer to use any programming language for his application.
The Roozz plugin shall be able to run programs on both Windows, Linux and Mac operating systems.
The Roozz plugin shall enable programmers who write their applications for the DotNet framework to distribute and run their application on both Windows, Linux and Mac without having any knowledge about cross platform development.

### Further Notes on Security Issues

The classical cryptography problem can be summarized in the following: Party A wants to send a secret message M to party B via an unsecured channel. Through another channel party B has received a security code which is needed to open the message M from party A. The cryptography technique is considered secure if party C cannot, in reasonable time, decrypt M even if party C knows which cryptographic technique is used and party C knows the content of the message M which was sent through the secure channel.

The majority of attacks on cryptosystems like the above are not targeted directly at the secure channel but on loopholes in the technology used to implement the cryptosystem. E.g. guess the password from knowledge about the person or hardware that generated the password for party A. Or intercept the alternative channel where the password was exchanged or stored.

In one embodiment of the system according to the invention party A corresponds to the few persons in the company owning the system with access to the database and the algorithm for creating the loader modules LM. Party B corresponds to the 3D data application on a client computer. The secret message M corresponds to the data files that the system is trying to protect from being duplicated or redistributed in an editable or viewable form. The party C can be any person (cracker) with evil intentions, not a member of group A, such as the end user of the application or a software developer inside the company.

Since party B is a software component residing on a client computer, this means that party C has unrestricted access to monitor all actions provided by party B. This fact makes it extremely difficult for party B to open the secret message M (the data files) without revealing the content and/or the password(s) to party C. Thus it is the objective of the system according to the invention to avoid that party C:
1. Obtains and/or distributes passwords to other parties D.
2. Obtains and/or distributes a crack that can enable other parties D to obtain the passwords and/or the content of the data files on their local machine when the application is running.
3. Obtains and/or distributes a crack and/or a software component that replaces the original software on the client and fools the server(s) in the system to trust the software is still the original and that the secure channel is intact.

The above objectives are obtained in the system according to the invention by:
1. Continuously changing the passwords to quickly make the passwords worthless both on the local machine and on other parties' machines, and/or
2. continuously reorder the location of passwords and/or data in memory (RAM) to make it difficult to automate the process of extracting passwords or data, and/or
3. distributing a small unique software component (i.e. the loader module LM) which authenticates the software on the client machine before it is initiated, at the same time the loader module LM continuously changes the number of passwords used and the protocol in the communication channel. This makes it impossible for party C to create a software component that can imitate the original software distribution. Thereby a secure channel for distribution of passwords is established.

To understand how the method of the system according to the invention can provide a system that is extremely hard to break, the techniques that can be used by a cracker to break the system is illustrated in the following:

Any file on the local hard drive can be duplicated and distributed without limitation. Such files can also be compared to other versions of the same file and this will immediately reveal the difference, i.e. whether this is an embedded password or a change in an algorithm or the reordering of the content.

When files (both program files and/or data files) are loaded into memory they must be decrypted to be accessible to the software. Since party C has unrestricted access to all information in the computer he can use debugging techniques to stop the execution of a program and look at the decrypted data in memory (RAM). Using such tools it is even possible to change how execution of the program loaded into memory is carried out.

However few persons have the knowledge, time and tools to search memory (RAM) to find the passwords. It is also possible to detect that some of these tools are running on a client computer, thus it is possible to halt the execution of the data protection system and exit if such a debugging tool is discovered. Other techniques similar to watchdog timers have also been used to detect when a cracker tool stop the execution before the cracker can make any changes. Thus, the system is considered safe if distribution of information that will enable other parties D to break the system with little effort can be avoided.

This requires that in the system according to the invention it should be very difficult to:
1. Distribute a crack (program or script which can run on party D's computer) which uses such debugging technique to reverse engineer the system software on D's computer and help a user to extract the passwords and/or content of the data files.
2. Distribute a short description (e.g. on a webpage), whereby crackers with little or medium experience can learn how to crack the system.
3. Crack the system using conventional cracking and debugging tools. One such example is a program called Softice.

1. A system for converting a first digital representation of a graphical object defined in two dimensions, such as a floor plan of a building such as a house or an apartment, into a second digital representation of said graphical object, said second digital representation defined in three dimensions, said system comprising:
means for converting the first digital representation into a vector based representation by means of an computer implemented algorithm, and
means for converting said vector based representation of the first digital representation into a three dimensional representation of the graphical object.

2. A system according to claim 1, furthermore comprising means for defining the first digital representation from marking a part of a digital bitmap by digital marking means such as a computer mouse, a pointing device, touch screen or the like.

3. A system according to any of the preceding claims, wherein the first digital representation is a graphical object in bitmap format.

4. A system according to any of the preceding claims, furthermore comprising means for generating a 3D walk-through model from the second digital representation.

5. A system according to any of the preceding claims, wherein the computer implemented algorithm comprises any of the following means:
means for identifying background color(s) and/or other colors in the first digital representation,
means for identifying and removing text from the first digital representation,
means for identifying and removing objects, symbols and/or pictograms, such as furniture, floor patterns or the like, from the first digital representation, said objects, symbols and/or pictograms not relevant for the floor plan,
means for identifying lines in the first digital representation,
means for identifying and removing digital background noise from the first digital representation,
means for identifying floor plan objects such as walls, rooms, partitions, doors, stairs, corners, windows, floorboards, floorboard patterns, tiles and/or the like, from the first digital representation,
means for identifying measurements and/or dimensions of said floor plan objects, and
means for inserting three dimensional representations of standard objects in the second digital representation, standard objects such as inner walls, outer walls, doors, stairs, windows, floor, ceiling, rooftop, tiles, floorboards, carpets, and/or the like.

6. A system according to any of the preceding claims, wherein the graphical object defined in two dimensions comprises a floor plan of a building with at least two floors wherein each floor is treated separately.

7. A system according to any of the preceding claims, furthermore comprising means for providing user input to assist in the process of converting the first digital representation into a vector based representation, user input such as the identification of relevant floor plan objects such as walls, partitions, doors, stairs, corners, windows, or the like, in the first digital representation.

8. A method of converting a first digital representation of a graphical object defined in two dimensions, such as a floor plan of a building such as a house or an apartment, into a second digital representation of said graphical object, said second digital representation defined in three dimensions, said method comprising the steps of:
converting the first digital representation into a vector based representation by means of an computer implemented algorithm, and
converting said vector based representation of the first digital representation into a three dimensional representation of the graphical object.

9. A method according to claim 8, furthermore comprising the step of defining the first digital representation from marking a part of a digital bitmap by digital marking means such as a computer mouse, a pointing device, touch screen or the like.

10. A method according to claims 8 and 9, wherein the first digital representation is a graphical object in bitmap format.

11. A method according to any of the claims 8 to 10, whereby a walk-through model is generated from the second digital representation.

12. A method according to any of the claims 8 to 11, wherein the computer implemented algorithm comprises any of the following steps:
identifying background color(s) and/or other colors in the first digital representation,
identifying and removing text from the first digital representation,
identifying and removing objects, symbols and/or pictograms, such as furniture, floor patterns or the like, from the first digital representation, said objects, symbols and/or pictograms not relevant for the floor plan,
identifying lines in the first digital representation,
identifying and removing digital background noise from the first digital representation,
identifying floor plan objects such as walls, rooms, partitions, doors, stairs, corners, windows, floorboards, floorboard patterns, tiles and/or the like, from the first digital representation,
identifying measurements and/or dimensions of said floor plan objects, and
inserting three dimensional representations of standard objects in the second digital representation, standard objects such as inner walls, outer walls, doors, stairs, windows, floor, ceiling, rooftop, tiles, floorboards, carpets, and/or the like.

13. A method according to any of the claims 8 to 12, wherein the graphical object defined in two dimensions comprises a floor plan of a building with at least two floors wherein each floor is treated separately.

14. A method according to any of the claims 8 to 13, furthermore comprising the step of providing user input to assist in the identification of relevant floor plan objects such as walls, partitions, doors, stairs, corners, windows, and/or the like, from the first digital representation.

15. A system for secure administration and/or provision of protected data files in a computer network, such as the Internet or a local LAN, said computer network comprising at least one server and a plurality of clients, said system comprising means for providing a loader module from at least one server to a client every time the client starts a new instance of the system, said loader module comprising:
a) means for providing data communication between the at least one server and said client,
b) means for validating protected files and unprotected files on the client by means of an hash function,
c) means for authenticating said loader module towards at least one server and subsequently providing at least one security code from said at least one server to the client to decrypt said protected files, and
d) means for encrypting and decrypting said protected files on the client and data communicated between the at least one server and said client.

16. A system according to claim 15, wherein data are exchanged between the at least one server and at least one client by means of a data communication protocol and wherein said data communication protocol is continuously varied, preferably varied in a random manner.

17. A system according to claim 16, wherein the data communication protocol is varied each time the at least one server provide said at least one security code from a server to a client, whereby data communication is provided through a unique data communication protocol.

18. A system according to any of the claims 15 to 17, wherein said loader module is different every time it is provided to a client, thereby making it difficult to attack and break the data protection provided by the loader module.

19. A system according to any of the claims 15 to 18, wherein a substantial amount of random data is integrated in the loader module each time said loader module is compiled on a server, whereby each compiled loader module is unique.

20. A system according to any of the claims 15 to 19, wherein a loader module is compiled on a server prior to said loader module is provided to a client, whereby a unique loader module is provided to each client.

21. A system according to any of the claims 15 to 20, wherein authentication of a client by a server is provided by means of a security code comprised in the loader module and/or by means of a message encrypted using a security code comprised in the loader module.

22. A system according to any of the claims 15 to 21, wherein the hash function is an SHA algorithm.

23. A system according to any of the claims 15 to 22, wherein the encryption and/or decryption algorithm is based ASE encryption.

24. A system according to any of the claims 15 to 23, wherein at least one security code is a password.

25. A system according to any of the claims 15 to 24, wherein no user login is required for a client to access at least one server.

26. A system according to any of the claims 15 to 24, wherein the loader module is exclusively loaded into non-volatile memory, such as the random access memory, at the client.

27. A system for launching applications on a client, such as a computer, through a computer network, such as the Internet or a local LAN, said computer network comprising at least one master server and a plurality of 3^{rd} party servers and a plurality of clients, said system comprising means for a user, connected to and/or associated with a client, to approve certificates from one or more specific 3^{rd} party supplier, subsequently said 3^{rd} party suppliers will be able to provide applications to be launched on said users client, said system further comprising means for periodically communicating with the at least one master server to validate the certificates approved by said user.

28. A system according to claim 27, wherein the at least one master server is managed by a master service provider and the 3^{rd} party servers are managed by other service providers.

29. A system according to claim 27, which comprises a web browser plugin, such as an ActiveX control or an npapi based plugin.

30. A system according to any of the claims 27 to 29, which comprises a subsystem for updating the users client with new software components and data files when these components or files become available in a newer version.

31. A system according to any of the claims 27 to 30, which comprises a subsystem for downloading software components and data files to the client, storing them exclusively in random access memory and using them from random access memory.

32. A system according to any of the claims 27 to 31, which comprises a subsystem for launching software applications into a new process running on the client and being able to project the visual output of the newly launched application to a specific region on a client screen controlled by the system.

33. A system according to any of the claims 27 to 32, wherein it is possible to build managed code software applications to be run on several different operating system and/or hardware platforms without having to compile specific versions for the different varieties of operating systems and/or hardware platforms.

34. A system according to any of the claims 27 to 33, wherein it is possible for the 3^{rd} party supplier to provide new versions of an application and/or an entirely new application to a client without requiring the user to approve a new certificate from the said 3^{rd} party supplier.

35. A system according to any of the claims 27 to 34, which provides any of the following steps when accepted by a user to run an application from a 3^{rd} party supplier on a client:
providing a certificate template from the at least one master server to the client,
providing a contract, such as a license agreement, for the user to accept, thereby establishing an agreement between the user and the 3^{rd} party service provider, said contract preferably comprised in said certificate template,
periodic validation of the 3^{rd} party supplier against the at least one master server,
providing the certificate from the at least one master server to the client, the certificate being encrypted with the master supplier private key and can be decrypted only with the master supplier public key, the certificate comprising a 3^{rd} party public key.
providing an encrypted app file, preferably an encrypted application .xml file, from the 3^{rd} party server to the client and subsequently decrypting the encrypted app file by means of the 3^{rd} party public key comprised in the certificate, said app file comprising information about application files on the 3rd party server,
providing application files from the 3^{rd} party server to the client based on the information comprised in the app file,
loading and running the application files from the 3^{rd} party server on the client.

36. A system according to any of the claims 27 to 35, wherein administration of protected data is provided by a system according to any of the claims 15 to 26.

37. A method for secure administration and/or provision of protected data files in a computer network, such as the Internet or a local LAN, said computer network comprising at least one server and a plurality of clients, said method comprising the step of providing a loader module from at least one server to a client every time the client starts a new instance on the at least one server, said loader module comprising:
a) means for providing data communication between the at least one server and said client,
b) means for validating protected files and unprotected files on the client by means of an hash function,
c) means for authenticating said loader module towards at least one server and subsequently providing at least one security code from said at least one server to the client to decrypt said protected files, and
d) means for encrypting and decrypting said protected files on the client and data communicated between the at least one server and said client.

38. A method according to claim 37, wherein data are exchanged between the at least one server and at least one client by means of a data communication protocol and wherein said data communication protocol is continuously varied, preferably varied in a random manner.

39. A method according to claim 37, wherein the data communication protocol is varied each time the at least one server provide said at least one security code from a server to a client, whereby data communication is provided through a unique data communication protocol.

40. A method according to any of the claims 37 to 39, wherein said loader module is different every time it is provided to a client, thereby making it difficult to attack and break the data protection provided by the loader module.

41. A method according to any of the claims 37 to 40, wherein a substantial amount of random data is integrated in the loader module each time said loader module is compiled on a server, whereby each compiled loader module is unique.

42. A method according to any of the claims 37 to 41, wherein a loader module is compiled on a server prior to said loader module is provided to a client, whereby a unique loader module is provided to each client.

43. A method according to any of the claims 37 to 42, wherein, authentication of a client by a server is provided by means of a security code comprised in the loader module and/or by means of a message encrypted using a security code comprised in the loader module.

44. A method according to any of the claims 37 to 43, wherein the hash function is an SHA algorithm.

45. A method according to any of the claims 37 to 44, wherein the encryption and/or decryption algorithm is based ASE encryption.

46. A method according to any of the claims 37 to 45, wherein at least one security code is a password.

47. A method according to any of the claims 37 to 46, wherein no user login is required for a client to access at least one server.

48. A method according to any of the claims 37 to 47, wherein the loader module is exclusively loaded into non-volatile memory, such as the random access memory, at the client.

49. A method for launching applications on a client, such as a computer, through a computer network, such as the Internet or a local LAN, said computer network comprising at least one master server and a plurality of 3^{rd} party servers and a plurality of clients, said method comprising the step of a user, connected to and/or associated with a client, approving certificates from one or more specific 3^{rd} party supplier, subsequently said 3^{rd} party suppliers will be able to provide applications to be launched on said users client, said method further comprising the step of periodically communicating with the at least one master server to validate the certificates approved by said user.

50. A method according to claim 49, wherein the at least one master server is managed by a master service provider and the 3^{rd} party servers are managed by other service providers.

51. A method according to claim 49, which comprises a web browser plugin, such as an ActiveX control or an npapi based plugin.

52. A method according to any of the claims 49 to 51, wherein a subsystem comprises means for updating the client with new software components and data files when these components or files become available in a newer version.

53. A method according to any of the claims 49 to 52, wherein a subsystem comprises means for downloading software components and data files to the client, storing them exclusively in random access memory and using them from random access memory.

54. A method according to any of the claims 49 to 53, which comprises a subsystem for launching software applications into a new process running on the client and being able to project the visual output of the newly launched application to a specific region on a client screen.

55. A method according to any of the claims 49 to 54, wherein it is possible to build managed code software applications to be run on several different operating system and/or hardware platforms without having to compile specific versions for the different varieties of operating systems and/or hardware platforms.

56. A method according to any of the claims 49 to 55, wherein it is possible for the 3^{rd} party supplier to provide new versions of an application and/or an entirely new application to the client without requiring the user to approve a new certificate from said 3^{rd} party supplier.

57. A method according to any of the claims 49 to 56, wherein any of the following steps is provided when a user has accepted to run an application from a 3^{rd} party supplier on a client:
providing a certificate template from the at least one master server to the client,
providing a contract, such as a license agreement, for the client to accept, thereby establishing an agreement between the user and the 3^{rd} party service provider, said contract preferably comprised in said certificate template,
periodic validation of the 3^{rd} party supplier against the at least one master server,
providing the certificate from the at least one master server to the client, the certificate being encrypted with the master supplier private key and can be decrypted only with the master supplier public key, the certificate comprising a 3^{rd} party public key.
providing an encrypted app file, preferably an encrypted application .xml file, from the 3^{rd} party server to the client and subsequently decrypting the encrypted app file by means of the 3^{rd} party public key comprised in the certificate, said app file comprising information about application files on the 3rd party server,
providing application files from the 3^{rd} party server to the client based on the information comprised in the app file,
loading and running the application files from the 3^{rd} party server on the client.

58. A method according to any of the claims 49 to 57, wherein administration of protected data is provided by a method according to any of the claims 37 to 48.

59. A computer program product having a computer readable medium, said computer program product providing a system for converting a first digital representation of a graphical object defined in two dimensions, such as a floor plan of a building such as a house or an apartment, into a second digital representation of said graphical object, said second digital representation defined in three dimensions, and said computer program product comprising means for carrying out any of the steps of any of the methods according to any of the claims 8 to 14.

60. A computer program product having a computer readable medium, said computer program product providing a system for secure administration and/or provision of protected data files in a computer network, such as the Internet or a local LAN, said computer network comprising at least one server and a plurality of clients, and said computer program product comprising means for carrying out any of the steps of any of the methods according to any of claims 37 to 58.
